(19) United States
(12) Patent Application Publication
(10) Pub. No.: US 2015/0082762 A1
(43) Pub. Date: Mar. 26, 2015

(54) Tree Trimmer

(71) Applicant: Plain Oaks Pty. Ltd., Nyora (AU)

(72) Inventors: David Stanley Silcock, Nyora (AU); Robert Gilbert Howell, Nyora (AU)

(73) Assignee: Plain Oaks Pty. Ltd., Nyora (AU)

(21) Appl. No.: 14/035,987

(22) Filed: Sep. 25, 2013

(51) Int. Cl. A01G 23/095; F16M 13/02

(52) U.S. Cl. CPC A01G 23/095; F16M 13/022
USPC 56/235; 248/276.1

(57) ABSTRACT

A tree trimming cluster of circular saws form part of an assembly on the hydraulic arm of a tractor and the assembly is adjustable hydraulically to allow the assembly to sweep from side to side, to incline in relation to the ground and to rotate with a wrist like action. In addition the whole assembly can rotate about a horizontal axis on the hydraulic arm giving an extra degree of adjustment. The hydraulic arm extends from a jib located behind the tractor driver and is capable of slewing. A variety of 4 m cuts are available which is useful for firebreak creation and powerline protection.

### FIELD OF THE INVENTION

This invention concerns equipment for trimming trees and shrubs using a tractor and especially the hydraulic mounting components for enabling the tractor to utilise ganged circular saws.

### BACKGROUND OF THE INVENTION

While much trimming of trees near powerlines is done by trained staff raised by cherry picker platforms and using chainsaws, the larger scale of rural sites requires large circular saws. It is useful to be able to present the blade at a vertical, horizontal and 45 degree angles in order to impart a desired profile to an avenue of trees lining a road or a cluster of trees near powerlines.

### SUMMARY OF THE INVENTION

The apparatus aspect of the invention provides a mount assembly for the hydraulic arm of a vehicle which is operable to manipulate an array of tree trimming cutters, the assembly comprising a hydraulic arm extension connectable at one end to the hydraulic arm and at the opposite end to a cutter arm via a coupling, the coupling allowing rotation about a vertical axis permitting side to side cutter arm sweeps and rotation about a first horizontal axis permitting the inclination of the cutters to the ground to be adjusted, the cutter arm being pivotally connected to the coupling at one end and pivotally connected to the array at the opposite end such that the array is rotatable about a second horizontal axis executing a wrist like action and fluid operated means to actuate the assembly.

The hydraulic arm extension pivots on the hydraulic arm about a first horizontal axis z. The coupling rotates about vertical axis y and about a second horizontal axis z¹ while the array rotates about horizontal axis x. The hydraulic arm which supports the assembly may be telescopic and capable of gaining the height required for the trimmer to cut the crown of a mature tree.

In a preferred embodiment the coupling has a first double bracket pivoted vertically to the extension at the front end thereof, the first double bracket is fixed to a second double bracket which provides a horizontal pivot for the depending cutter arms and a ram connected between the first double bracket and the extension arm produces arcuate swings in the cutter arm.

The upper end of the cutter arm is pivotally connected to the second double bracket and a ram connected between the cutter arm and the second double bracket is operable to change the inclination of the array.

The lower end of the cutter arm is pivotally connected to the array box and a ram connected between the cutter arm and the array box executes the wrist action through 90 degrees.

The hydraulic arm extension has a pivot connection to the hydraulic arm and a fluid operated ram allowing the assembly to rotate about a third horizontal axis.

The cutters are circular saw blades which overlap circumferentially.

The array is linear and the blades are 800-990 mm in diameter and separated from each other by about 20 mm.

The invention may also be described as a mount assembly for the hydraulic arm of a vehicle which is capable of manipulating a tree trimming cutter, the assembly comprising a hydraulic arm extension which permits both rotation about a vertical axis permitting side to side sweeps and rotation about a first horizontal axis to adjust the inclination of the cutters to the ground, a cutter arm connected at one end to the coupling and pivotally connected at the opposite end to a multiple cutter array such that the array is rotatable about a second horizontal axis mimicing wrist action.

The hydraulic arm may in turn be pivoted to a jib extending from the rear part of the chassis of a tractor. The two together constituting a jib and dipper arm commonly used in rural infrastructure operations. In this way the trimmer may have an arc of operation of 14-16 m.

The multiple cutter array may be an elongated mount with a common drive for two, three or four circular saw blades. Thus a cutting band of 3-4 m is available.

The cutter array may rotate between a horizontal trimming path and a vertical trimming path, wherein the 90 degree rotation mimics wrist action. When the cutters are following a horizontal trimming path the cutter arm depends from the coupling.

### BRIEF DESCRIPTION OF THE DRAWINGS

One embodiment of the invention is now described with reference to the accompanying drawings, in which:

FIG. 1 is a diagram of a tractor with a jib, dipper arm and cutter assembly according to the invention at ground level.

FIG. 2 is a side view of the trimmer assembly. Hydraulic hoses for the assembly rams have been omitted for clarity in this and the following two figures.

FIG. 3 is a perspective of the trimmer assembly of FIG. 5.

FIG. 4 is an opposite side view of the trimmer assembly.

FIG. 5 is a rear diagrammatic view of a tractor trimming in an upright plane.

FIG. 6 is a rear diagrammatic view of a tractor trimming in a horizontal plane.

FIG. 7 is a rear diagrammatic view of a tractor trimming at 45 degrees.

### DETAILED DESCRIPTION WITH RESPECT TO THE DRAWINGS

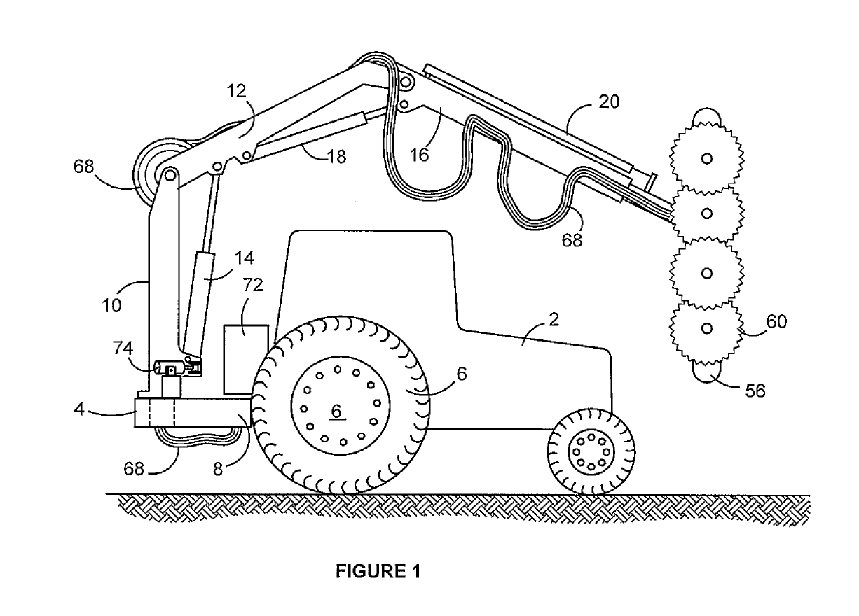

Referring now to the drawings, in FIG. 1 the 130HP tractor 2 has a chassis extension 4 to the rear of the back wheels 6 and the extension supports a circular slewing base 8 from which an upright jib 10 extends. Such equipment is supplied by Hiab Australia Pty Ltd. Jib arm 12 is pivoted to the top of the jib and is raised and lowered by ram 14. Dipper arm 16 is pivoted to the end of the jib arm and in turn raised and lowered by ram 18. The dipper arm 16 is telescopic and is adjusted by ram 20. It is to the telescoping end of the dipper arm 16 that the trimmer assembly 22 is connected.

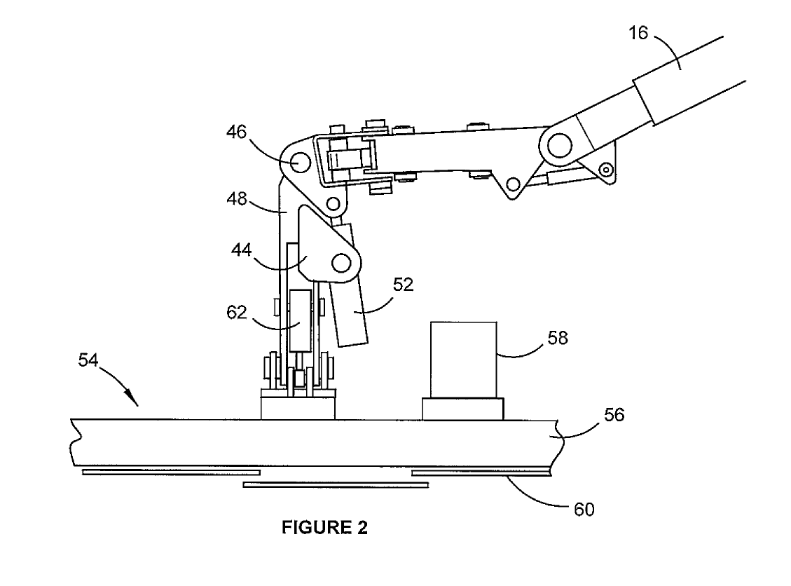

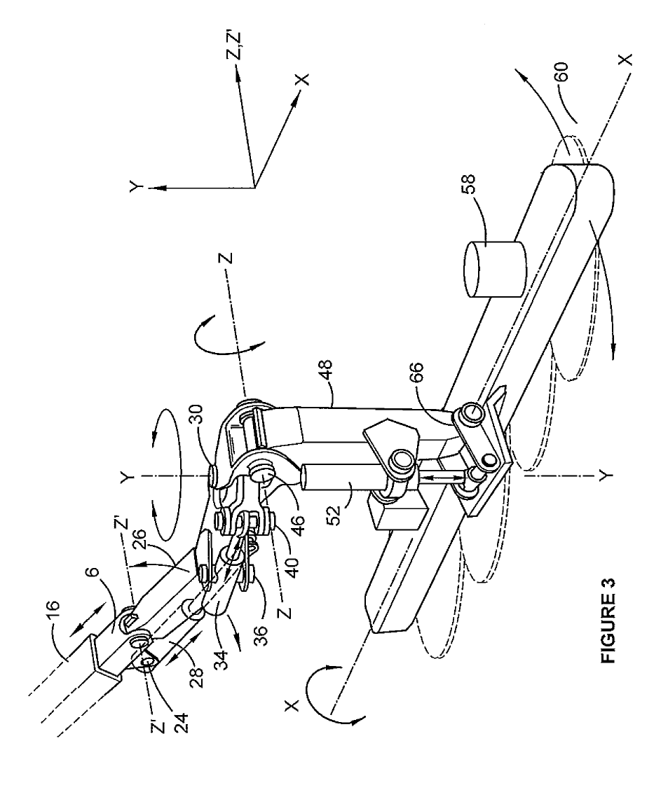

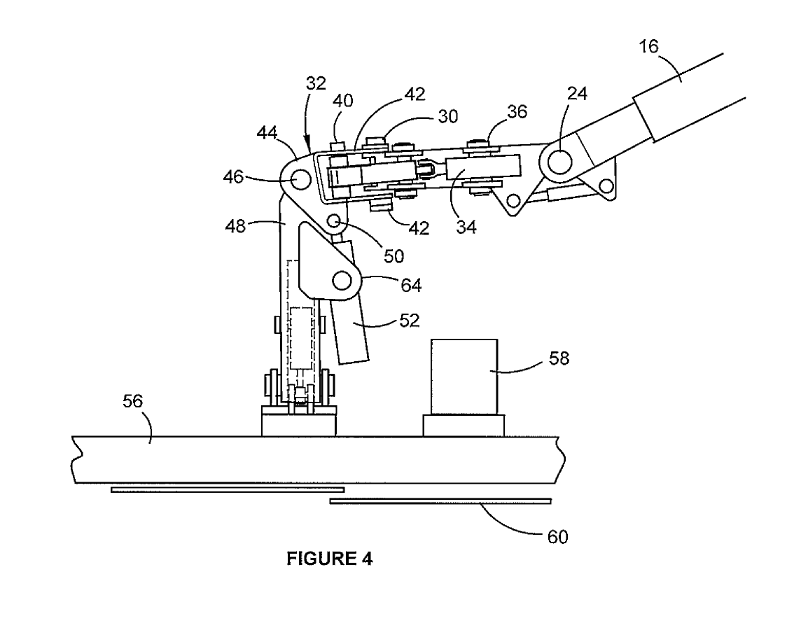

Referring now to FIGS. 2 and 3, the leading telescopic end of dipper arm 16 has a horizontal pivot 24 in the z axis about which arm extension 26 raises and lowers by the force of ram 28. The leading end of the extension has a pivot pin 30 in the y axis about which coupling 32 rotates through 270 degrees. This rotation is the result of the action of ram 34 which is centrally mounted on upright pin 36 in turn mounted on brackets 38 which extend sideways from arm extension 26. Ram 34 reacts on thrust pin 40 which extends between horizontal walls 42 of a first double bracket forming one half of coupling 32. Ram 34 exerts its lateral force on pin 40 through link 42.

The remaining half of the coupling is formed by a pair of parallel walls 44 which form a second double bracket. These walls support horizontal pin 46 from which cutter arm 48 depends. Walls 44 also support thrust pin 50 which enables ram 52 to rotate the cutter arm through 120 degrees about a second z axis.

Multiple cutter array 54 consists of a drive housing 56 to which is fixed hydraulic motor 58. This drives all four 825 mm saw blades 60 at 25,000 rpm. The axis of the cutter array lies in an x axis and is rotatable about the x axis by a ram 62 held parallel to cutter arm 48 by brackets 64. Ram 62 actuates cranks 66 to which housing 56 is welded. Such motion produces a wrist like action in the housing turning the blades through 90 degrees. The hydraulic motor 58 is driven by the tractor hydraulics through large diameter hoses 68. These take the major part of the tractor output.

The assembly rams are supplied from the same tractor hydraulics by hoses 70 (see FIG. 1) which are also slung under the dipper arm and suspended where possible to allow maximum movement to the arm extension 26, coupling 32 and cutter arm 48. Tank 72 holds hydraulic oil. Slewing ram 74 is mounted beside the jib.

The stability of the vehicle is improved if the jib is offset by a suitable distance.

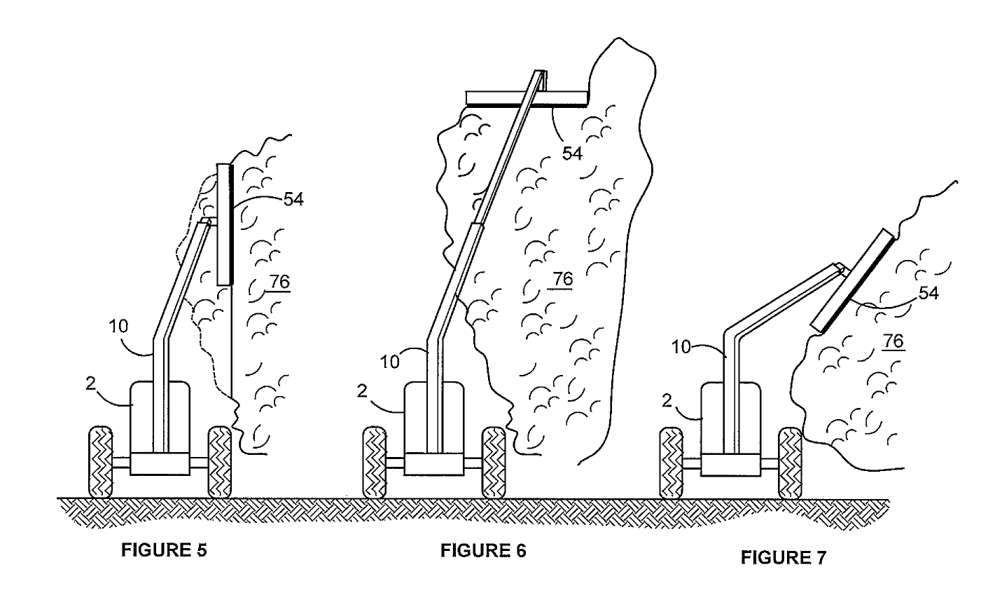

Referring now to FIGS. 5, 6 and 7, in use the driver surveys the wooded site for powerlines, obstructions and limbs of trees likely to fall if struck by the cutter assembly. The driver drives the tractor on the grass verge alongside the trees to be trimmed and extends the dipper arm to reach the desired height. The blades are arranged through the hydraulic controls to lie parallel to the desired cut. The blades are rotated at cutting speed and the slewing control rotates the jib and dipper arm toward the growth 76 to be cut. The tractor progresses and the saw cuttings fall to the ground in advance of the tractor. The tractor drives over them but is followed by a mulcher which breaks them into compostable mix.

We have found the advantages of the above embodiment to be:

1. Trimming can produce geometric accuracy. It can also produce landscaping effects which are aesthetically pleasing. It can cut firebreaks in forests.

2. The cuts can be adjusted to ensure the felled branches are of a size which can be mulched by available equipment.

3. A speed of 3 km/hr is attainable.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

We claim:

1. A mount assembly for the hydraulic arm of a vehicle which is operable to manipulate an array of tree trimming cutters, the assembly comprising a hydraulic arm extension connectable at one end to the hydraulic arm and at the opposite end to a cutter arm via a coupling, the coupling allowing rotation about a vertical axis permitting side to side cutter arm sweeps and rotation about a first horizontal axis permitting the inclination of the cutters to the ground to be adjusted, the cutter arm being pivotally connected to the coupling at one end and pivotally connected to the array at the opposite end such that the array is rotatable about a second horizontal axis executing a wrist like action and fluid operated means to actuate the assembly.

2. A mount assembly as claimed in claim 1, wherein the coupling rotates about vertical axis y.

3. A mount assembly as claimed in claim 2, wherein the cutter arm rotates about a first horizontal axis z¹.

4. A mount assembly as claimed in claim 3, wherein the array rotates about a second horizontal axis x.

5. A mount assembly as claimed in claim 4, wherein the hydraulic arm extension pivots on the hydraulic arm about a first horizontal axis z.

6. A mount assembly as claimed in claim 5, wherein the cutter array is an elongated mount with a common drive for one of two, three or four circular blades.

7. A mount assembly as claimed in claim 6, wherein the cutter array rotates between a horizontal trimming path and a vertical trimming path by execution of a wrist-like action.

8. A mount assembly as claimed in claim 1, wherein the cutters are circular saw blades which overlap circumferentially.

9. A mount assembly as claimed in claim 7, wherein the array is linear.

10. A mount assembly as claimed in claim 9, wherein the blades are 800-990 mm in diameter.

11. A mount assembly as claimed in claim 1, wherein the coupling has a first double bracket pivoted vertically to the extension arm at the front end thereof, the first double bracket is fixed to a second double bracket which provides a horizontal pivot for the depending cutter arms and a ram 34 connected between the first double bracket and the extension arm produces arcuate swings in the cutter arm.

12. A mount assembly as claimed in claim 11, wherein the cutter arm has an upper end and a lower end, the upper end is pivotally connected to the second double bracket and a ram connected between the cutter arm and the second double bracket is operable to change the inclination of the array.

13. A mount assembly as claimed in claim 12, wherein the lower end of the cutter arm is pivotally connected to the array box and a ram connected between the cutter arm and the array box executes the wrist action through 90 degrees.

14. A mount assembly as claimed in claim 11, wherein the hydraulic arm extension has a pivot connection to the hydraulic arm and a fluid operated ram allowing the assembly to rotate about a third horizontal axis.

15. A tractor with a jib and dipper arm to which is fitted a mount assembly as claimed in claim 1.

16. A tractor as claimed in claim 15 wherein the jib slews.
